(19) United States
(12) Patent Application Publication
(10) Pub. No.: US 2024/0422538 A1
(43) Pub. Date: Dec. 19, 2024

(54) SECURE AUTHENTICATION VIA NONORTHOGONAL MESSAGE AND TAG TRANSMISSION IN WIRELESS RELAY NETWORKS

(71) Applicant: Iowa State University Research Foundation, Inc., Ames, IA (US)

(72) Inventor: Sang Wu Kim, Ames, IA (US)

(21) Appl. No.: 18/746,784

(22) Filed: Jun. 18, 2024

Related U.S. Application Data
(60) Provisional application No. 63/508,928, filed on Jun. 19, 2023.

(51) Int. Cl. H04W 12/06; H04L 9/08; H04L 9/32

(52) U.S. Cl. CPC H04W 12/06; H04L 9/088; H04L 9/3242

(57) ABSTRACT

A framework for message authentication in wireless relay networks, leveraging non-orthogonal multiple access (NOMA) is provided. In this framework, the source transmits the message to the destination through a relay, while the tag is directly sent to the destination. One advantage of our approach is its resilience against integrity attacks. Even if the adversary manages to extract the key from the message and tag pair and generate a valid tag for a modified message, the modification can still be detected at the destination using the tag received directly from the source. To further enhance security, a crypto-physical message authentication scheme that combines cryptographic message authentication with physical-layer message authentication is provided. This fusion of authentication schemes offers synergistic benefits. The authenticated throughput is derived and the performance improvement achieved by the crypto-physical message authentication is assessed compared to solely relying on cryptographic message authentication.

### CROSS-REFERENCE TO RELATED PATENT APPLICATIONS

This patent application claims the benefit of U.S. Provisional Patent Application No. 63/508,928, filed Jun. 19, 2023, the entire teachings and disclosure of which are incorporated herein by reference thereto.

### STATEMENT REGARDING FEDERALLY SPONSORED RESEARCH AND DEVELOPMENT

This invention was made in part with Government support under NSF Contract Number ITE2226447 awarded by the National Science Foundation. The Government has certain rights in the invention.

### FIELD OF THE INVENTION

This invention generally relates to frameworks for message authentication in wireless relay networks, and more particularly to frameworks for message authentication in wireless relay networks that leverage non-orthogonal multiple access (NOMA).

### BACKGROUND OF THE INVENTION

Relays are extensively utilized in various wireless networks, such as cellular, satellite, and WiFi, to extend coverage and enhance network capacity. However, the presence of relays also introduces data integrity challenges. One critical concern is the threat of data integrity attacks, where a relay maliciously modifies packets during transit. This type of attack is particularly detrimental as maliciously altered data can disrupt system operations. For example, in healthcare applications, if a packet containing personal health information is modified by a malicious relay, it could lead to fatal erroneous treatment decisions. Therefore, ensuring data integrity as data traverse through relays becomes a fundamental requirement. As used herein “data integrity” refers to the assurance that data remain unchanged and unaltered in an unauthorized or accidental manner.

Traditional methods for ensuring data integrity involve appending a message authentication code (MAC), also known as a tag, to the data to detect modifications during transit. However, this approach has drawbacks, such as requiring additional bandwidth to transmit the tag and vulnerability to key extraction by adversaries for data integrity attacks (substitution attacks). Embedding a low-power tag onto the data can make key recovery difficult for adversaries, but it weakens the receiver's ability to authenticate valid data.

Previous works related to these issues can be summarized as including Overheard Signal Correlation and Physical Layer Signal Watermarking/Fingerprinting. For Overheard Signal Correlation, in S. Dehnie et al., “Detecting malicious behavior in cooperative diversity,” 41st Annual Conference on Information Sciences and Systems, pp. 895-899, IEEE, 2007, a physical layer message authentication scheme is presented where the destination correlates the overheard signal from the source with the signal received from the relay. By comparing the correlation to a predefined threshold, data modification is detected. Similarly, in W. Hou et al., “Misbehavior detection in amplify-and-forward cooperative ofdm systems,” IEEE Int. Conf. on Communications (ICC), pp. 5345-5349 (2013), and in E. Graves et al., “A coding approach to guarantee information integrity against a Byzantine relay,” IEEE International Symposium on Information Theory (ISIT), pp. 2780-2784 (2013), related approaches are proposed where data modification is detected at the source by utilizing the transmitted signal as a reference.

In Physical Layer Signal Watermarking/Fingerprinting, physical layer authentication schemes, such as those discussed in L. Y. Paul et al., “Physical-layer authentication,” IEEE Transactions on Information Forensics and Security, vol. 3, no. 1, pp. 38-51, 2008 and L. Y. Paul et al., “Wireless physical layer authentication via fingerprint embedding,” IEEE Communications Magazine, vol. 53, no. 6, pp. 48-53, 2015, involve embedding a cryptography-based authentication code or tag into the original data signal. This embedded fingerprint has low bandwidth requirements and is designed to make recovery difficult for adversaries. The authors analyze the advantages of embedding a low-power tag onto the data by assessing the effort required for adversaries to learn the secret key from the embedded fingerprints. However, reducing the power of the tag embedding also weakens the receiver's ability to authenticate valid packets.

More recent developments in physical layer message authentication include the utilization of likelihood ratio tests and maximum a posteriori (MAP) tests based on the physical-layer signals. These tests are performed on erroneous packets (hard-decisioned observations) that the destination directly receives or overhears from the source nodes. Studies have shown that the detection error probability decreases exponentially with an increasing number of source nodes, indicating that the multiplicity of nodes can be leveraged to construct a robust message authentication mechanism.

To detect message modifications in short packets, previous research has explored the serial concatenation of cryptographic detection and physical-layer detection, as well as the parallel concatenation approach. However, all of the aforementioned physical layer detection schemes utilize hard-decisioned observations of binary source messages.

### BRIEF SUMMARY OF THE INVENTION

To overcome the challenges discussed above, embodiments of the present disclosure provide a novel message authentication scheme in relay networks that leverage non-orthogonal multiple access (NOMA). NOMA enables simultaneous transmission of multiple messages over the same frequency bandwidth, with receivers employing successive interference cancellation (SIC) for decoding. In certain embodiments, the message is sent through a relay to the destination, while the tag is directly sent to the destination. Even if the (adversarial) relay successfully extracts the key and generates a valid tag for a modified message, the destination can detect the modification using the tag received directly from the source. This inherent security against data integrity attacks does not require reducing the tag power, thus preserving the destination's ability to authenticate the message.

However, message authentication becomes challenging when the message and/or the tag are received with errors. To address this issue, certain embodiments provide a physical-layer message authentication technique that can detect data modification even in the presence of errors. This technique exploits the noisy information provided by the physical-layer signal to validate the authenticity of the received message. Furthermore, certain embodiments provide a crypto-physical message authentication scheme that combines physical-layer message authentication with cryptographic message authentication, leveraging the synergistic benefits of both authentication schemes.

Embodiments of the present invention provide contributions for Authentication Error Rate (AER) Analysis, Likelihood Ratio Test for Error-Prone Tag Reception, and Crypto-Physical Message Authentication. For Authentication Error Rate (AER) Analysis, embodiments derive the AER for the NOMA-aided cryptographic message authentication scheme and compare it with the orthogonal multiple access (OMA)-based cryptographic message authentication, where the message and tag are transmitted over separate orthogonal channels.

For Likelihood Ratio Test for Error-Prone Tag Reception, embodiments provide a likelihood ratio test to detect message modifications at the physical layer, specifically when the tag is received with errors. Such embodiments derive the AER as a function of parameters such as signal-to-noise ratio (SNR), power allocation between the message and tag, and message length.

For Crypto-Physical Message Authentication, embodiments provide a crypto-physical message authentication mechanism that combines cryptographic message authentication with physical layer authentication. This integration leverages the strengths of both schemes, and the performance improvement achieved by the crypto-physical message authentication over conventional cryptographic message authentication can be analyzed.

Certain embodiments focus on the fundamental limits of throughput in the presence of a data integrity attack using soft-decisioned (unquantized) observations of Gaussian source messages. This approach allows investigation of the fundamental performance bounds in terms of throughput when facing data integrity attacks.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a system model in which x is an encoded message of the source S and x′ is a modification of x by the relay R;

FIGS. 2A and 2B represent an orthogonal transmission of the original message-tag pair (x, t) and modified message-tag pair (x′, t′);

FIGS. 3A and 3B represent a Downlink NOMA: Non-orthogonal transmission of the message \tilde{x} and the tag \tilde{t}=e(h(k, m′)) to R and D, respectively;

FIGS. 4A and 4B represent an Uplink NOMA: Non-orthogonal transmission of the modified message \tilde{x}′ and the tag \tilde{t}=e(h(k, m′)) to D;

FIG. 5 is a block diagram of crypto-physical message authentication scheme; and

FIG. 6 is an authentication throughput, T, versus average signal-to-noise ratio, γ (dB), between the source and the destination in which n=512, m=64, R=2 (bits per channel use), d_{sd}=1, dₛᵣ=d_{sd}/2, d_{rd}=d_{sd}/2, and path loss exponent=4.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Embodiments of the present disclosure relate to seamless transmission of a tag directly from the source to the destination, empowering the destination to verify the authenticity of a received message from a relay. This capability remains intact even when a valid tag is provided alongside a counterfeit message. This feature significantly strengthens security measures against a computationally powerful adversary (relay) who can extract the key from the message and tag pair, subsequently generating a valid tag for a counterfeit message. It is believed that embodiments of the present disclosure address imminent security threats posed by advanced computing technologies, such as quantum computing.

According to a first aspect, a novel framework for secure message authentication in wireless relay networks, leveraging nonorthogonal multiple access (NOMA) technique, is provided. In this framework, the source transmits the message to the destination through a relay, while the tag is directly sent to the destination. One advantage of such embodiment is its resilience against substitution attacks. Even if the adversary manages to extract the key from the message and tag pair and generate a valid tag for a modified message, the modification can still be detected at the destination using the tag received directly from the source. In the traditional scheme, both the message and the tag are sent through the relay, allowing the relay to tamper with the message without being detected. To further enhance security, according to a second aspect, certain embodiments provide a crypto-physical message authentication scheme that combines cryptographic message authentication with physical-layer message authentication. This fusion of authentication schemes offers synergistic benefits. These and other aspects and advantages will be described more fully below in the embodiments described herein and depicted in the figures. Such embodiments are provided by way of illustration and not limitation.

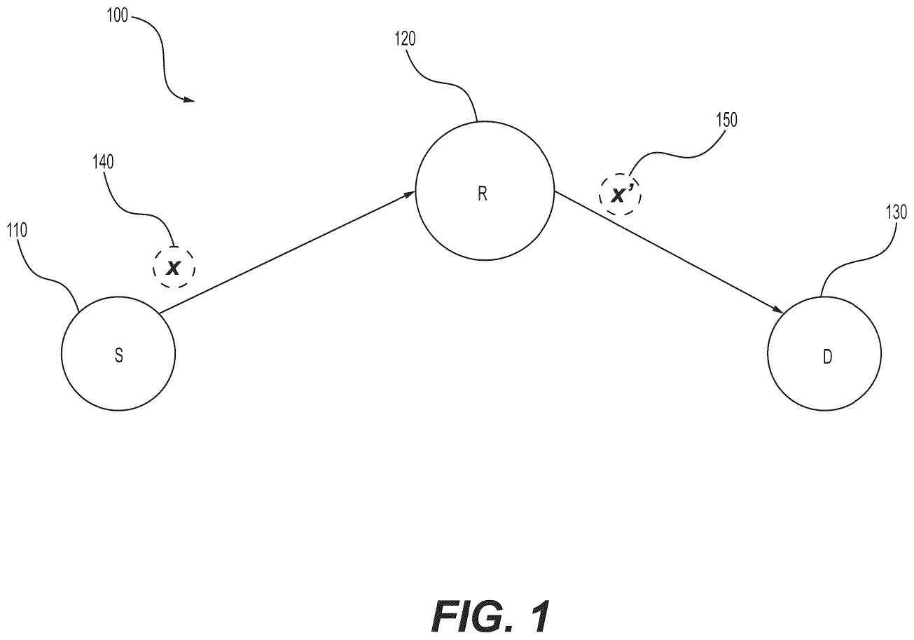

FIG. 1 schematically depicts an exemplary embodiment of a system 100, in particular a wireless relay network, such as a cellular (in particular 5G) telecommunications or internet-of-things (IoT) network. The system 100 includes a source 110, a relay 120, and a destination 130. The source 110 transmits a message 140 to the destination 130 through the relay 120. The message 140 is a codeword with a rate of R bits per channel use.

In one or more embodiments, the source 110 is a base station, i.e., a fixed transceiver, such as a cell tower (microcell, small cell, and/or femtocell). In one or more embodiments, the relay 120 is a repeater equipped with antennas, a transceiver, and optionally an amplifier, such as a microwave relay, a broadcast relay station, or a cellular repeater, among other possibilities. Further, the relay 120 may be a stationary relay (such as a fixed relay attached to a building) or mobile relay (such as a relay attached to a vehicle or a cellular device that acts as a relay). In one or more embodiments, the destination 130 is a user's cellular device, an autonomous vehicle, an internet-of-things (IoT) device (any of a variety of devices comprising one or more sensors, actuators, and communication interfaces for monitoring or controlling a process). While the system 100 is depicted as including one source 110, one relay 120, and one destination 130, in reality, the system 100 may include several of each of the source 110, the relay 120, and the destination 130, including of multiple different varieties of each.

In order to demonstrate how the disclosed method enhances the security of wireless relay networks 100, an attack model will be described in relation to FIG. 1. According to one scenario of attack, an adversary compromises the relay 120 so as to modify the message 140 received at the relay 120 before forwarding it to the destination 130. The modified message 150 is denoted as x′=(x′¹, . . . , x′ₙ₋ₘ). The adversary's goal is to ensure that the modification goes undetected by the destination 130. To evade detection, e.g., by the cyclic redundancy check (CRC), the adversary modifies the message to be a valid codeword such that both x and x′ belong to the same codebook.

It is assumed that the adversary is computationally powerful (e.g., employing quantum computing) and can extract the key by observing the message and tag pair. With complete knowledge of the key and the tag-generating function, the adversary can generate valid tags for their messages, making them appear genuine to the destination. Hence, relying solely on node authentication techniques to verify the source of the received packet x′ is insufficient. Instead, it is necessary to verify the integrity of the received message x′.

Cryptographic message authentication is a technique that verifies the integrity of a received message using a tag. To calculate the tag for a message x, a secret key k shared between the source 110 and destination 130, a one-way hash function h( ) and channel encoding e( ) are employed. The tag t is obtained by applying the hash function h( ) to the key k and message m, followed by channel encoding e( )

$$t = e ( h ( k , m ) ) \qquad ( 1 )$$

Here, m represents the information part of the codeword (message) x, i.e., e(m)=x.

Assume that the tag t=(t₁, t₂, . . . , tₘ) is a codeword of length m symbols and rate R bits per channel use. Both x and t are selected from independent codebooks. Additionally, it is assumed that E[xᵢ]=E[tⱼ]=0 and E[|xᵢ|²]=E[|tⱼ|²]=P for i∈1, . . . , n-m and j∈1, . . . , m.

In accordance with FIG. 1, the destination 130 decodes the message x′ received from the relay 120. In particular, m′ represents the information portion of the message x′, and the destination 130 validates m′ by computing e(h(k, m′)) and comparing it with the tag t. The received message m′ is accepted if e(h(k, m′))=t and, otherwise, rejected. If the length of the codeword multiplied by the channel rate (i.e., mR) is large enough, e.g. 128, the relay 120 will highly likely be unable to compute a valid tag e(h(k, m′)) which is identical to t.

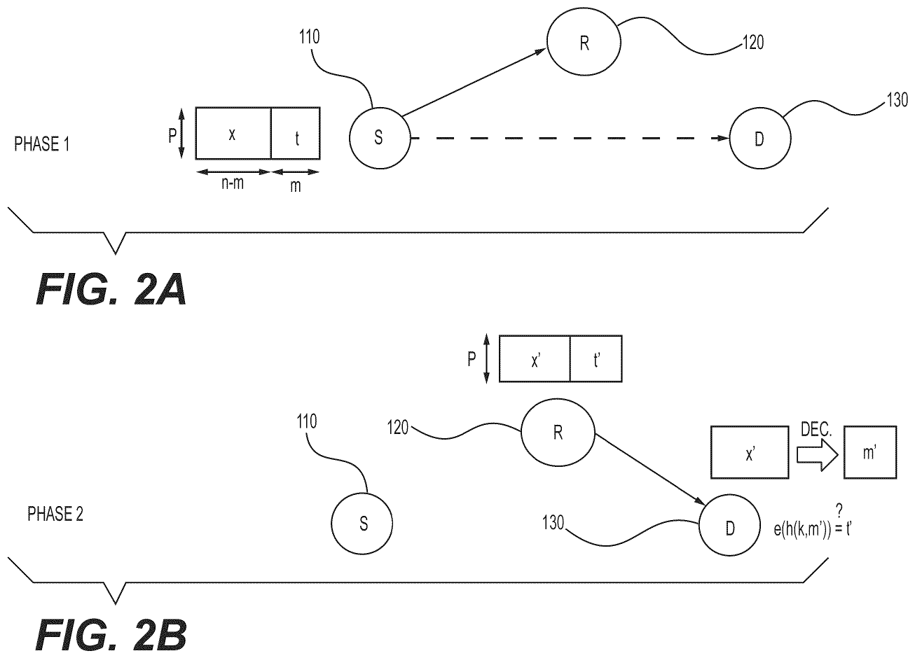

FIGS. 2A-4B consider three methods for transmitting the message and the tag to the destination.

Using orthogonal multiple access (OMA), the message x and the tag t are sent in two phases, as depicted in FIGS. 2A and 2B. In phase 1 shown in FIG. 2A, the source 110 transmits the message x and the tag t to both the relay 120 and the destination 130. The received signals at the relay 120 and the destination 130 are given by:

$${y}_{sr} = {h}_{sr} {x}_{s} + {n}_{sr} {y}_{sd} = {h}_{sd} {x}_{s} + {n}_{sd} \qquad ( 2 )$$

Here, xₛ is the concatenation of the message x and the tag t transmitted by the source 130, hₛᵣ and h_{sd} are the channel gains between the source 110 and the relay 120 and between the source 110 and the destination 130, respectively, and nₛᵣ and n_{sd} are additive white Gaussian noise with zero mean and variance σₙ².

In phase 2 as shown in FIG. 2B, the relay 120 modifies the message x to another codeword x′=e(m′), and then forwards x′|t′ to the destination 130. Here, t′=e(h(k, m′)) represents the tag for the modified message x′. It is assumed that if the relay 120 fails to decode the message x, it sends an arbitrary codeword x′. The received signal at the destination 130 is given by:

$${y}_{rd} = {h}_{rd} {x}_{s}^{′} + {n}_{rd} . \qquad ( 3 )$$

Here, xₛ′=x′∥t′, h_{rd} is the channel gain between the relay 120 and the destination 130, and n_{rd} is the additive white Gaussian noise with zero mean and variance σₙ².

The effective transmission rate Rₑ (in bits per channel use) is given by:

$${R}_{e} = R / 2 \qquad ( 4 )$$

The factor of 2 accounts for the utilization of two orthogonal channels in transmitting a codeword x and a tag t.

In describing the OMA transmission, certain assumptions were made. First, the channel gains hₛᵣ, h_{sd}, and h_{rd} are independent complex Gaussian random variables with zero mean. This implies that their magnitudes follow a Rayleigh distribution, and their phases are uniformly distributed on the interval [0, 2π]. Second, the variances of hₛᵣ, h_{sd}, and h_{rd} are denoted as λₛᵣ, λ_{sd}, and λ_{rd}, respectively. The variances λₛᵣ, λ_{sd}, and λ_{rd} are related to the distances between the corresponding nodes source 110, relay 120, and destination 130. Specifically, if the distance d between nodes a and b is denoted as d_{ab}, where a and b each refer to one of the source 110 (ₛ), relay 120 (ᵣ), and destination 130(_{d}), then λ_{ab}=d^{-l}, where l is the path loss exponent. Third, quasi-static Rayleigh block fading channels were considered, i.e., the channel gains remain constant within a block (corresponding to a codeword transmission) and change independently from one block to another.

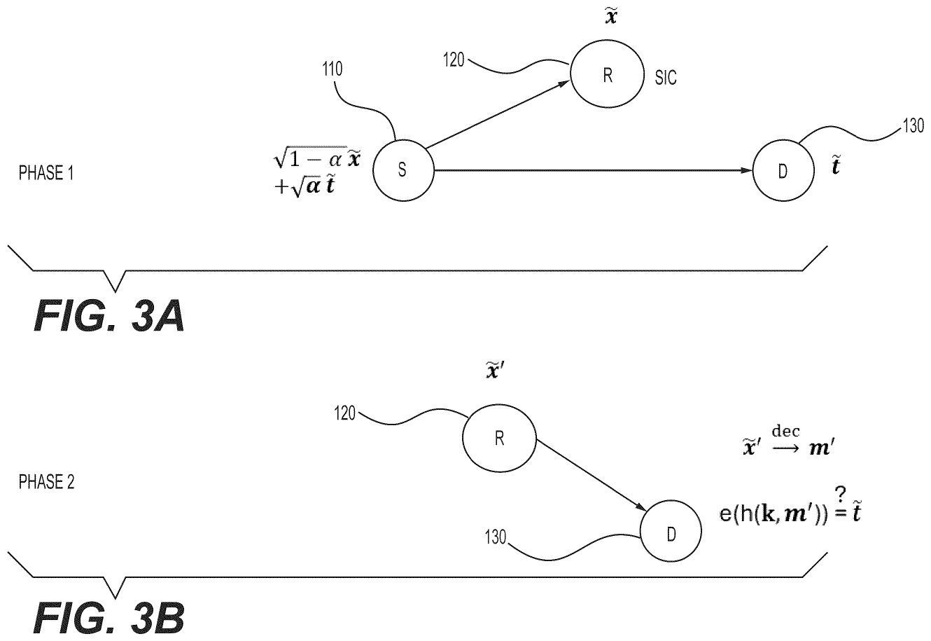

According to the present disclosure, a cryptographic message authentication scheme using Downlink Non-Orthogonal Multiple Access (D-NOMA) is now described in relation to FIGS. 3A and 3B. In phase 1 as shown in FIG. 3A, the source 110 simultaneously sends the message x and the tag t to the relay 120 and the destination 130, respectively. To enhance reliability, m parity symbols are added to the original message codeword x=(x₁, . . . , xₙ₋ₘ), resulting in a new codeword \tilde{x}=(x₁, . . . , xₙ) with a length of n and a rate of Rₓ=(1-m/n)R bits per channel use. Similarly, n-m parity symbols are added to the original tag t=(t₁, . . . , tₘ), resulting in a new tag \tilde{t}=(t₁, . . . , tₙ) with a length of n and a rate of Rₜ=mR/n bits per channel use. This addition of parity symbols improves decoding reliability. In particular, if n is sufficiently long such that Rₜ is low enough, then the tag can be correctly decoded by the destination 130 even with a weak signal strength, i.e., the destination 130 is located far from the source 110. It is important to note that this code rate adjustment does not alter the amount of information bits contained within the message and the tag; they remain (n-m)R and mR bits, respectively, identical to the conventional OMA scheme.

The transmitted signal xₛ from the source 110 is given by:

$${x}_{s} = \sqrt{1 - α} \tilde{x} + \sqrt{α} \tilde{t} \qquad ( 5 )$$

where a∈(0, 1) represents the power allocation between the message \tilde{x} and the tag \tilde{t}. The received signals yₛᵣ and y_{sd} at the relay 120 and the destination 130, respectively are given by:

$${y}_{sr} = {h}_{sr} {x}_{s} + {n}_{sr} \qquad ( 6 )$$

$${y}_{sd} = {h}_{sd} {x}_{s} {n}_{sd} . \qquad ( 7 )$$

The destination 130 performs decoding by treating the \tilde{x} term as interference and decodes the \tilde{t} term from y_{sd}. Similarly, the relay 120 decodes \tilde{t} from yₛᵣ. If successful, \tilde{t} is removed from yₛᵣ and \tilde{x} is decoded from the remaining signal. Otherwise, \tilde{x} is decoded from yₛᵣ while treating \tilde{t} as interference. This process is known as successive interference cancellation (SIC).

In phase 2 as shown in FIG. 3B, the relay 120 modifies \tilde{x} into another codeword \tilde{x}′ and forwards it to destination 130. The received signal at the destination 130 is given by:

$${y}_{rd} = {h}_{rd} {\tilde{x}}^{′} + {n}_{rd} . \qquad ( 8 )$$

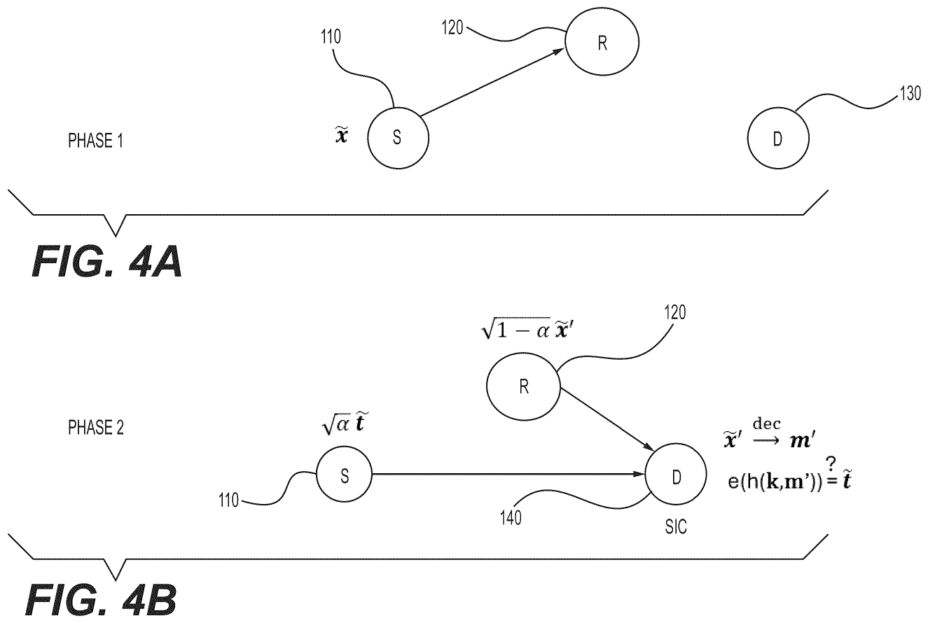

According to further embodiments of the present disclosure, a cryptographic message authentication scheme using uplink Non-Orthogonal Multiple Access (U-NOMA) is described in relation to FIGS. 4A and 4B. In U-NOMA, the source 110 sends the message \tilde{x} to the relay 120 in phase 1 as shown in FIG. 4A. The received signal at the relay 120 is given by equation (2). In phase 2 as shown in FIG. 4B, the relay 120 modifies \tilde{x} into another codeword \tilde{x}′, and then the source 110 and the relay 120 simultaneously send the tag \tilde{t} and \tilde{x}′ to the destination 130.

The received signal at the destination 130 is given by

$${y}_{d} = {h}_{rd} \sqrt{1 - α} {\tilde{x}}^{′} + {h}_{sd} \sqrt{α} \tilde{t} + {n}_{d} . \qquad ( 9 )$$

The destination 130 decodes \tilde{x}′ from y_{d} treating \tilde{t} as interference. If the decoding is successful, \tilde{x}′ is removed from y_{d} and \tilde{t} is decoded from the remaining signal. Otherwise, \tilde{t} is decoded from y_{d} treating \tilde{x}′ as interference.

If a computationally powerful adversary manages to extract the key k from the (\tilde{x}, \tilde{t}) pair and possesses complete knowledge of the tag generating function and channel encoding rule, the adversary can generate a valid tag \tilde{t}′=e(h(k, m′)) for a modified message m′ and attempt to deceive the destination 130 into accepting it as authentic. Therefore, traditional node authentication techniques, which only verify the source 110 of the received packet \tilde{x}′, are insufficient. Instead, it is necessary to verify the integrity of the received message \tilde{x}′.

The integrity check approach of certain embodiments according to the present disclosure provides security against such integrity attacks. Even if the adversary (i.e., relay) generates a valid tag e(h(k, m′)) for a modified message m′, it can still be detected by the destination because e(h(k, m′))≠\tilde{t}. This is because \tilde{t} is received directly from the source 110 and cannot be modified by the adversary. As a result, the scheme of this embodiment is inherently secure against a computationally powerful adversary attempting to generate a valid tag for a modified message.

The distinction between D-NOMA and U-NOMA lies in the location where successive interference cancellation (SIC) is performed. In D-NOMA, SIC is conducted at the relay 120, whereas in U-NOMA, SIC is executed at the destination 130. The choice between the two depends on the availability of resources and the computational capabilities of the relay 120 and the destination 130. If the relay 120 possesses more resources and computational power, D-NOMA may be preferred. Conversely, if the destination 130 has greater resources and computational capabilities, U-NOMA may be more suitable.

An authentication error occurs when the destination incorrectly decides that the received message x′ (or \tilde{x}′) is authentic (miss detection) or when x′ (or \tilde{x}′) is incorrectly classified as authentic when it is not (false alarm). The authentication error rate (AER), which is the sum of the miss detection probability P_{M} and the false alarm probability P_{F}, quantifies the accuracy of the authentication decision.

With cryptographic message authentication, if both t and x′ (\tilde{t} and \tilde{x}′) are successfully decoded, the AER is zero. However, if either t or x′ (\tilde{t} or \tilde{x}′) is not decoded, cryptographic authentication cannot be performed. In the case of a random decision, where P_{M}=P_{F}=0.5, the AER is equal to one. Therefore, the AER with cryptographic message authentication is given by

$$ξ = 1 - ( 1 - {P}_{e , {x}^{′}} ) ( 1 - {P}_{e , t} ) , \qquad ( 10 )$$

where P_{e,x′} is the decoding error probability of x′ (\tilde{x}′) and P_{e,t} is the decoding error probability of t (\tilde{t}). The average AER can be computed by averaging ξ over |hₛᵣ|², |h_{rd}|², and |h_{sd}|².

The need to decode the tag for verifying the integrity of the received message poses a challenge in cryptographic message authentication, particularly in scenarios with a limited number of channel uses in short packets. In such cases, it may not be possible to decode the tag due to constraints on channel resources. To overcome this challenge, certain embodiments utilize a hybrid authentication scheme that leverages physical-layer (PHY) tag signals, y_{sd} and y_{d}, to verify the integrity of the received message x′ (\tilde{x}′) when the tag cannot be decoded. These PHY tag signals contain the true tag information, albeit corrupted by noise and fading, and can serve as a reference for integrity verification.

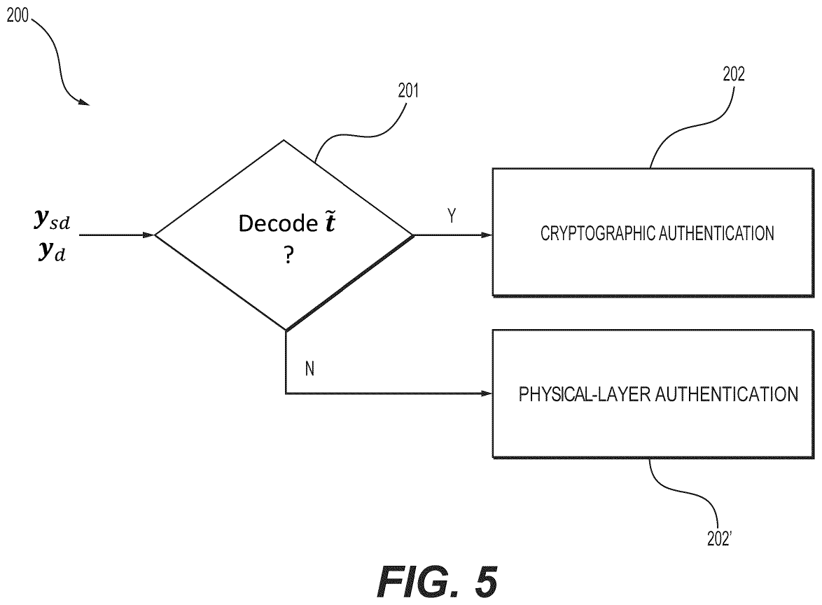

The hybrid authentication scheme, named “crypto-physical message authentication,” combines physical-layer authentication and cryptographic message authentication. The hybrid authentication scheme 200 is depicted in FIG. 5. In a first step 201, it is determined whether the tag t can be decoded. In a first case where \tilde{t} can be decoded, cryptographic message authentication is utilized in a second step 202. In a second case where the tag \tilde{t} cannot be decoded, the physical-layer authentication, such as any of the physical-layer authentications described above, is employed in an alternative second step 202′. This hybrid approach ensures that the integrity of the received message is verified even when the tag cannot be decoded. By incorporating physical-layer authentication, the proposed scheme aims to achieve a lower authentication error rate (AER) compared to crypto-graphic message authentication alone.

In this section numerical results are provided, assuming that the distance between the source and the destination is 1. So, the received SNR at the destination is equal to the transmit SNR γ for the signal sent by the source.

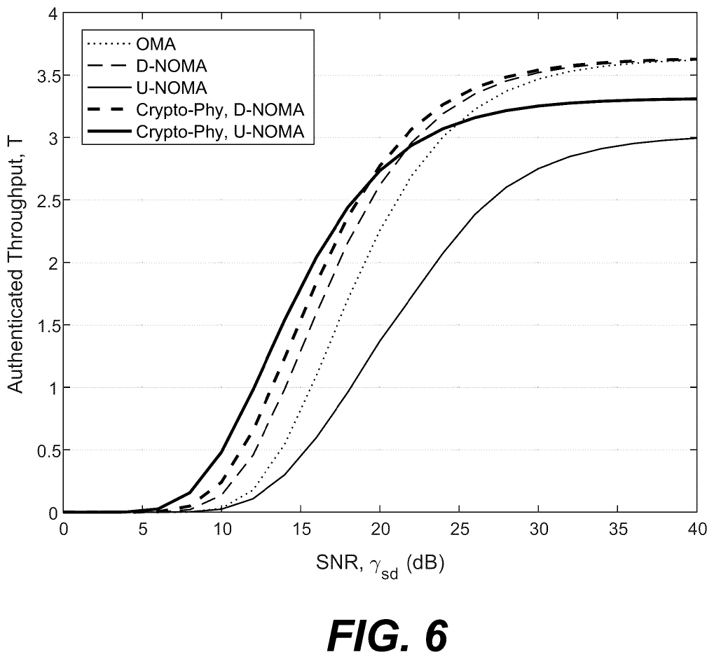

FIG. 6 illustrates the authenticated throughput (T) versus the SNR between S and D, γ_{sd}. The authenticated throughput represents the amount of information that can be reliably delivered and verified by the destination per channel use. Notably, the crypto-physical authentication (thick lines) significantly outperforms the cryptographic method (thin lines), especially at low SNRs where tag decoding is challenging. Moreover, at low SNRs, crypto-physical authentication with U-NOMA shows an advantage over that with D-NOMA at lower SNRs. However, at high SNRs, cryptophysical authentication with D-NOMA shows an advantage over that with U-NOMA.

Accordingly, the present disclosure has described embodiments of a NOMA-aided message authentication scheme for wireless relay networks. The authentication error rate was derived for NOMA-aided cryptographic authentication scheme, and the analysis considered the impact of SNR and transmission rate on the detection error probability. The findings indicate that NOMA-aided message authentication outperforms OMA, offering a lower AER. The improvement is more pronounced with longer block length. However, message authentication becomes challenging when the message and/or the tag are received with errors. To address this issue, certain embodiments provide a crypto-physical message authentication scheme that combines physical-layer message authentication with cryptographic message authentication, leveraging the synergistic benefits of both authentication schemes. This scheme achieves a significantly lower AER compared to cryptographic authentication schemes. The findings indicate that the improvement is more pronounced with OMA at longer block lengths and higher transmission rates.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for secure message authentication in a wireless network comprising a source, a relay, and a destination, the method comprising:
transmitting a first message from the source to the relay
transmitting a second message from the relay to the destination;
transmitting a first tag from the source to the destination;
utilizing, at the destination, the first tag transmitted by the source to verify that the second message transmitted by the relay corresponds to the first message transmitted by the source.

2. The method according to claim 1, wherein the source transmits the first message to the relay and transmits the first tag to the destination according to a nonorthogonal multiple access (NOMA) protocol.

3. The method according to claim 1, wherein a secret key is shared between the source and destination and wherein the first tag is calculated by applying a hash function to the first message and the secret key to obtain a hash and then channel encoding the hash for sending to the destination.

4. The method according to claim 1, wherein transmitting the first message further comprises transmitting a first signal comprising the first message and the first tag from the source to the relay while simultaneously transmitting the first signal comprising the first message and the first tag from the source to the destination;
wherein transmitting the second message further comprises transmitting a second signal comprising the second message and a second tag from the relay to the destination; and
wherein utilizing the first tag further comprises:
extracting the first tag from the first signal at the destination;
checking whether the second tag received from the relay matches the first tag received from the source such that the destination determines (i) that the second message corresponds to the first message if the second tag matches the first tag or (ii) that the second message does not correspond to the first message if the second tag does not match the first tag.

5. The method according to claim 4, wherein extracting further comprises treating, at the destination, the first message as interference and decoding the first tag from the first signal.

6. The method according to claim 5, wherein the relay conducts successive interference cancellation to extract the first message from the first signal followed by transmitting the second signal.

7. The method according to claim 1, wherein transmitting the second message and transmitting the first tag occur simultaneously such that the destination receives a signal comprising the second message and the first tag; and
wherein utilizing the first tag further comprises:
calculating a second tag from the second message by applying a hash function to the second message and a secret key shared between the source and destination; and
checking whether the second tag calculated from the second message matches the first tag transmitted by the source such that the destination determines (i) that the second message corresponds to the first message if the second tag matches the first tag or (ii) that the second message does not correspond to the first message if the second tag does not match the first tag.

8. The method according to claim 7, wherein prior to utilizing the first tag, the method further comprises:
decoding, by the destination, the second message from the signal by treating the first tag as interference;
removing the second message from the signal to produce a remaining signal; and
decoding the first tag from the remaining signal.

9. The method of claim 1, wherein utilizing the first tag further comprises:
decoding the first tag, when possible, to carry out a cryptographic authentication; or
utilizing physical-layer authentication of the first tag when decoding the first tag is not possible.

10. The method of claim 1, wherein the wireless network is one of a cellular telecommunications network or an internet-of-things network.

11. A system for secure message authentication in a wireless network, the system comprising:
a source configured to transmit a first message and a first tag;
a relay configured to receive the first message from the source and to transmit a second message; and
a destination configured to receive the first tag directly from the source and the second message from the relay;
wherein the destination utilizes the first tag to verify that the second message transmitted by the relay corresponds to the first message transmitted by the source.

12. The system according to claim 11, wherein the source is further configured to transmit the first message to the relay and transmit the first tag to the destination according to a nonorthogonal multiple access (NOMA) protocol.

13. The system according to claim 11, wherein the source and the destination share a secret key and wherein the source is further configured to calculate the first tag by applying a hash function to the first message and the secret key to obtain a hash and then channel encode the hash for sending to the destination.

14. The system according to claim 11, wherein the source is further configured to transmit a first signal comprising the first message and the first tag to the relay while simultaneously transmitting the first signal comprising the first message and the first tag to the destination;
wherein the relay is further configured to transmit a second signal comprising the second message and a second tag to the destination; and
wherein the destination is configured to utilize the first tag by extracting the first tag from the first signal at the destination and checking whether the second tag received from the relay matches the first tag received from the source such that the destination determines (i) that the second message corresponds to the first message if the second tag matches the first tag or (ii) that the second message does not correspond to the first message if the second tag does not match the first tag.

15. The system according to claim 14, wherein, to extract the first tag, the destination is configured to treat the first message as interference and decoding the first tag from the first signal.

16. The system according to claim 15, wherein the relay is configured to conduct successive interference cancellation to extract the first message from the first signal followed by transmitting the second signal.

17. The system according to claim 11, wherein the source is further configured to transmit the first message simultaneously to the relay and to the destination;
wherein the relay and the source are further configured to simultaneously transmit the second message and the first tag, respectively, such that the destination receives a signal comprising the second message and the first tag; and
wherein the destination is configured to utilize the first tag by calculating a second tag from the second message by applying a hash function to the second message and a secret key shared between the source and the destination and check whether the second tag calculated from the second message matches the first tag transmitted by the source such that the destination determines (i) that the second message corresponds to the first message if the second tag matches the first tag or (ii) that the second message does not correspond to the first message if the second tag does not match the first tag.

18. The system according to claim 17, wherein prior to utilizing the first tag, the destination is configured to decode the second message from the signal by treating the first tag as interference, remove the second message from the signal to produce a remaining signal, and decode the first tag from the remaining signal.

19. The system of claim 11, wherein the destination is further configured to utilize the first tag by (i) decoding the first tag, when possible, to carry out a cryptographic authentication or (ii) utilizing physical-layer authentication of the first tag when decoding the first tag is not possible.

20. The system of claim 11, wherein the wireless network is one of a cellular telecommunications network or an internet-of-things network.
